(19) United States
(12) Patent Application Publication
(10) Pub. No.: US 2009/0115149 A1
(43) Pub. Date: May 7, 2009

(54) DYNAMIC BALANCING PERSONAL VEHICLE

(76) Inventors: Scott E. Wallis, San Antonio, TX (US); Brian G. R. Hughes, San Antonio, TX (US)

Correspondence Address: HAYES SOLOWAY P.C., 3450 E. SUNRISE DRIVE, SUITE 140, TUCSON, AZ, 85718, US

(21) Appl. No.: 12/265,611

(22) Filed: Nov. 5, 2008

Related U.S. Application Data
(60) Provisional application No. 60/985,576, filed on Nov. 5, 2007.

(51) Int. Cl. B60G 17/00

(52) U.S. Cl. 280/6.159

(57) ABSTRACT

A seating system to be easily attached to an existing dynamic balancing personal vehicle is provided. The seating system allows both seated and standing use of the dynamic balancing personal vehicle, and provides for activation of rider present sensors contained in the foot platform of the dynamic balancing personal vehicle by the weight of the rider on the seating system. The seating system also provides for secure transfer of rider forces into the attached dynamic balancing personal vehicle, as well as shock attenuation, rider height adjustment, and rider center of gravity trimming. Alternatively, a dynamic balancing transportation system incorporating a flexible seating system for a rider is provided.

### CROSS REFERENCE TO RELATED APPLICATION

The present application claims the benefit of Provisional Application 60/985,576 filed Nov. 5, 2007.

### FIELD OF THE INVENTION

The present application relates to improvements in dynamic balancing personal vehicles. The invention has particular utility as improvements to dynamic balancing personal vehicles such as are available commercially under the trade name “SEGWAY PERSONAL TRANSPORTER”, from Segway, Inc., Manchester, N.H., and will be described in connection with such utility, although other utilities are contemplated.

### BACKGROUND

Self-powered, user guidable dynamic balancing personal vehicles are available commercially and are described in the patent art. See, for example, U.S. Pat. No. 5,871,091, the contents of which are incorporated by reference. Vehicles of this type operate in a mode in which motion of the vehicle, including acceleration is controlled partially or entirely by leaning or weight shift of the subject riding the vehicle.

While self-balancing personal vehicles have achieved a certain amount of commercial success, they have several limitations. For example, they require the user to stand. This can be tiring, particularly for the elderly and/or infirm, and may be difficult or impossible for the mobility impaired.

At least two after-market seat attachments are available commercially (Segseat.com and Segvator.com). The manufacturer of the Segway also has proposed the addition of a seat. See, for example, U.S. Pat. No. 6,561,294, U.S. Pat. No. 7,004,271 and U.S. Pat. No. 7,273,116 each of which is hereby incorporated by reference.

### BRIEF SUMMARY OF THE INVENTION

The present invention provides among other things improvements in personal dynamic balancing vehicles. In one aspect, the present invention provides a vehicle interface unit for attaching a variety of rider interfaces to a dynamic balancing personal vehicle (DBPV). The rider interfaces envisioned include those that would allow standing, seated and elevated rider positions while operating the DBPV. The vehicle interface unit is secured to the DBPV so that forces from the rider are reliably transferred to the DBPV. The vehicle interface unit allows for rapid adjustment of the height of the rider interface while mounted on the DBPV. The depth of the rider interface “receiver” built into the vehicle interface determines the amount of height adjustment available. In a preferred embodiment six or more inches of vertical adjustment is provided. The absolute height of the rider seat is determined by the design of the rider interface.

The rider interface receiver of the vehicle interface unit floats relative to the frame of the vehicle interface unit that is coupled to the DBPV. In one embodiment, the rider interface receiver is connected within the vehicle interface unit by a four-bar linkage that allows the rider interface receiver to move vertically through the two-step vertical movement relative to the DBPV. The first part of the vertical movement, e.g. ¼″ to ½″ travel, which is controlled by a spring, a cam and a cam follower, engages the rider present sensor switches in the DBPV to tell the vehicle that a rider is on board. The second part of the vertical movement, which may be 1″ to 2″, is controlled by a built-in shock reducer, preferably a combination of mechanical and gas springs, to reduce shock loads on the rider, the vehicle interface, and the entire DBPV system. The combination of functions, (rider force transfer into the DBPV, activation of rider present sensor switches, height adjustment and shock reduction), in the vehicle interface unit simplifies the rider interfaces, and allows for rapid switching of rider interfaces to meet the needs of the rider.

In another aspect, the present invention provides a seating system for mounting to a DBPV that permits rapid transition from standing only operation, standing with support operation, standing to seated to standing operation, and seated only operation. The “standing with support operation and standing to seated to standing operation” seat system in the preferred embodiment employs a seat similar to a unicycle design as the rider interface to permit use both in a standing and seated mode. The seat is mounted on a rail that permits the user to move the seat back and forth to trim their center of gravity on the DBPV. The rider uses height adjustment provided by the vehicle interface unit and rider interface to set the height of the seat to the rider's preference while either off the DBPV or while standing on the DBPV. The “seated only operation” seat system in another embodiment employs a platform or bench seat which limits use to a seated only mode. The seating platform is mounted on a frame that permits the user to move the seating platform back and forth to trim the rider's center of gravity on the DBPV. The rider uses height adjustment provided by the vehicle interface and rider interface to set the height of the platform to the rider's preference while off the DBPV. The addition of a powered, or mechanically advantaged lift system allows for height adjustment while the rider is on the platform.

In another embodiment of the invention, the stock steering handle used in DBPV is replaced by an adjustable height steering stick, e.g. as shown in FIG. 9. In the fully collapsed “short stick” position this allows a rider to mount a platform or bench seat from the front or sides. In the fully extended “tall stick” position, the rider could remove the “seated only operation” rider interface and stand on the DBPV, and still reach the steering control.

In yet another embodiment of the invention, the stock steering handle used in DBPV is replaced by a hands-free steering bar located between the legs of the user, e.g. as shown in FIG. 10. This frees the hands of the rider such that the rider may carry tools, or engage in sports or other activities where use of the hands is desirable. In a particular embodiment, the steering bar includes an adjustable height post, and a handgrip.

It is an object of the invention to provide a dynamic balancing personal vehicle configured to accommodate a seated user.

It is another object of the invention to provide a seating system to be easily attached to a conventional commercially available dynamic balancing personal vehicle, such as a SEGWAY PERSONAL TRANSPORTER dynamic balancing personal vehicle, without modifying any of the software of the commercially available vehicle.

It is another object of the invention to allow hands-free operation of a DBPV.

It is another object of the invention to allow dynamic access to elevated work spaces.

It is yet another object of the invention to provide improved mobility and comfort for the mobility impaired.

### BRIEF DESCRIPTION OF THE SEVERAL VIEWS OF THE DRAWINGS

A more complete understanding of the present invention may be reached by referring to the following description in connection with the following illustrative figures. In the figures, like reference numbers refer to like elements or acts throughout the figures.

FIG. 1 depicts a rear perspective view of the dynamic balancing personal vehicle (DBPV) including a specific seating system of the present disclosure;

FIG. 2 depicts a close up perspective view of the seating system of FIG. 1;

FIG. 3 depicts a close up side view of the seating system of FIG. 1;

FIG. 4 depicts two cut away views of the seating system of FIG. 3;

FIG. 5 depicts a close up perspective view of the base and floating support of the seating system couple to the foot platform of the dynamic balancing personal vehicle of FIG. 1;

FIG. 6 depicts an exploded view of the several pieces of the base and floating support of the seating system including the foot pad linkage to trigger the rider present sensors of the dynamic balancing personal vehicle of FIG. 1;

FIG. 7 depicts a close up perspective view of the height adjustment pin system of the seating system of FIG. 1;

FIG. 8 depicts a close up cutaway view of the height adjustment pin system of FIG. 7;

FIG. 9 depicts a perspective view of the seating system with a platform seat and adjustable steer bar for front mounting; and

FIGS. 10a and 10b depict perspective views of the dynamic balancing personal vehicle with a hands free steer bar.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed invention may be applied. The full scope of the invention is not limited to the examples that are described below.

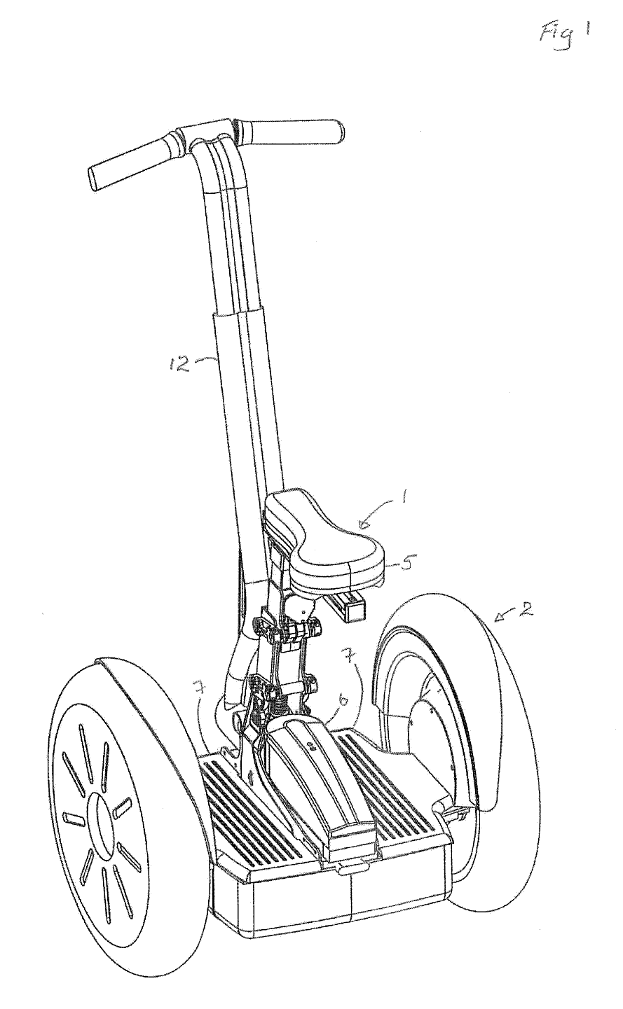

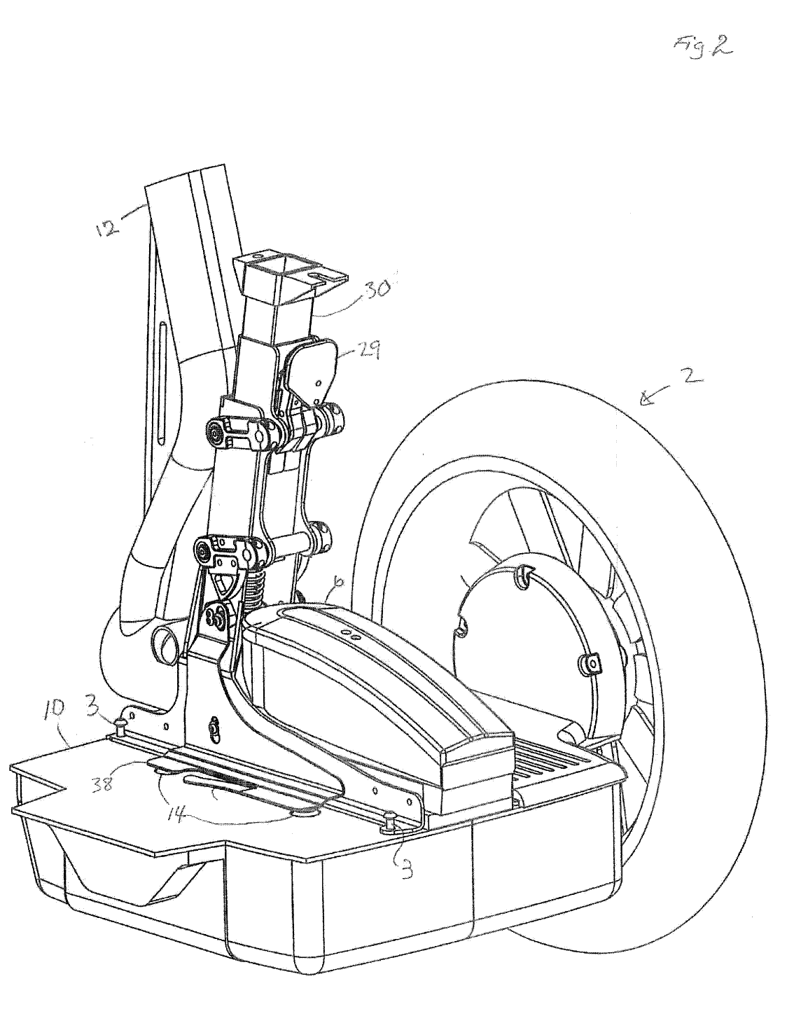

Referring to FIGS. 1-9, there is shown a seat system 1 mounted to an commercially available 2^{nd} generation SEGWAY PERSONAL TRANSPORTER (i2 version) dynamic balancing personal vehicle (DBPV) 2 that permits both standing and seated operation. The seating system serves the following functions. A) The seating system 1 securely transfers the rider's weight and force to the DBPV 2. B) The seating system 1, when loaded by the rider, activates the rider present sensors 14 in the DBPV 2. C) The seating system 1 reduces shock loads on the rider and DBPV 2. D) The seating system 1 provides for the easy exchange of the built-in shock reducer 22 to match the loads of a specific rider. E) The seating system 1 allows a variety of rider interfaces to be quickly and securely exchanged, with no modifications to the software of the DBPV. F) The seating system 1 allows the height of the rider interface to be quickly and securely adjusted. G) The seating system 1 allows for operation of the DBPV 2 in a variety of configurations, i) standing on the foot mats 7 with a narrow seating surface 5 providing lateral support between the rider's legs, ii) sitting on a narrow seating surface 5 between the rider's legs, iii) sitting on a wide seating surface 64 under the rider, iv) standing on the foot mats 7 and steering the DBPV 2 with a leg steer stick 52 between the rider's legs, and v) standing on an elevated platform 64 and steering with an elevated leg steer stick 53 between the rider's legs, and vi) other rider interfaces as may be attached to the vehicle interface unit, or base.

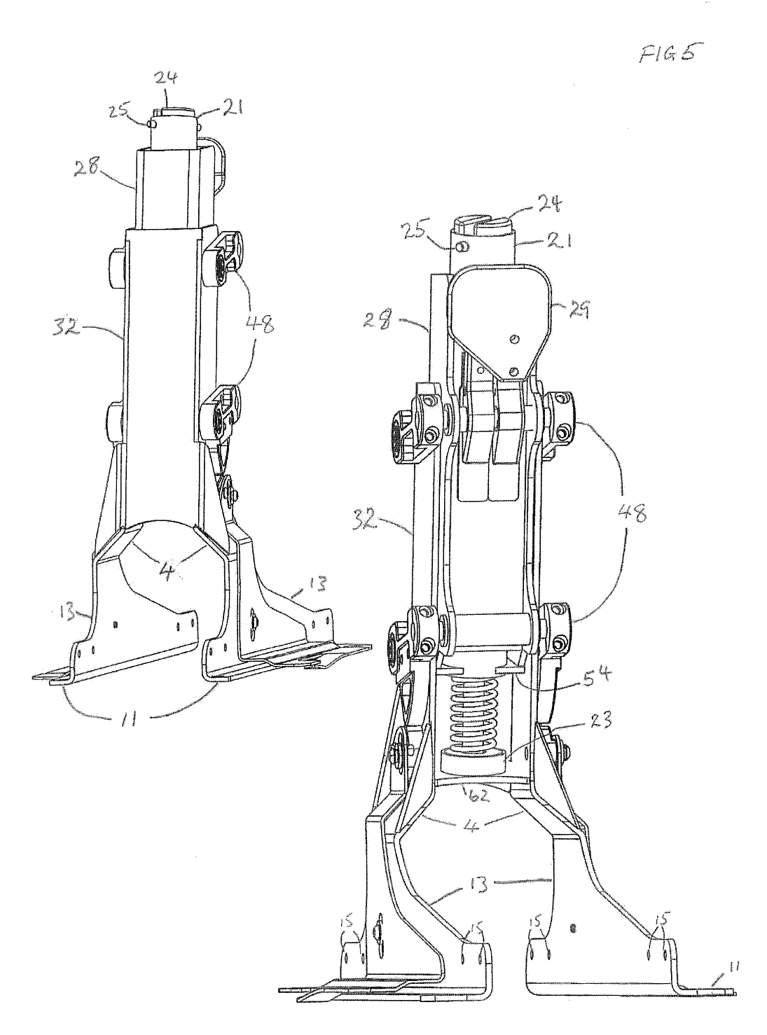

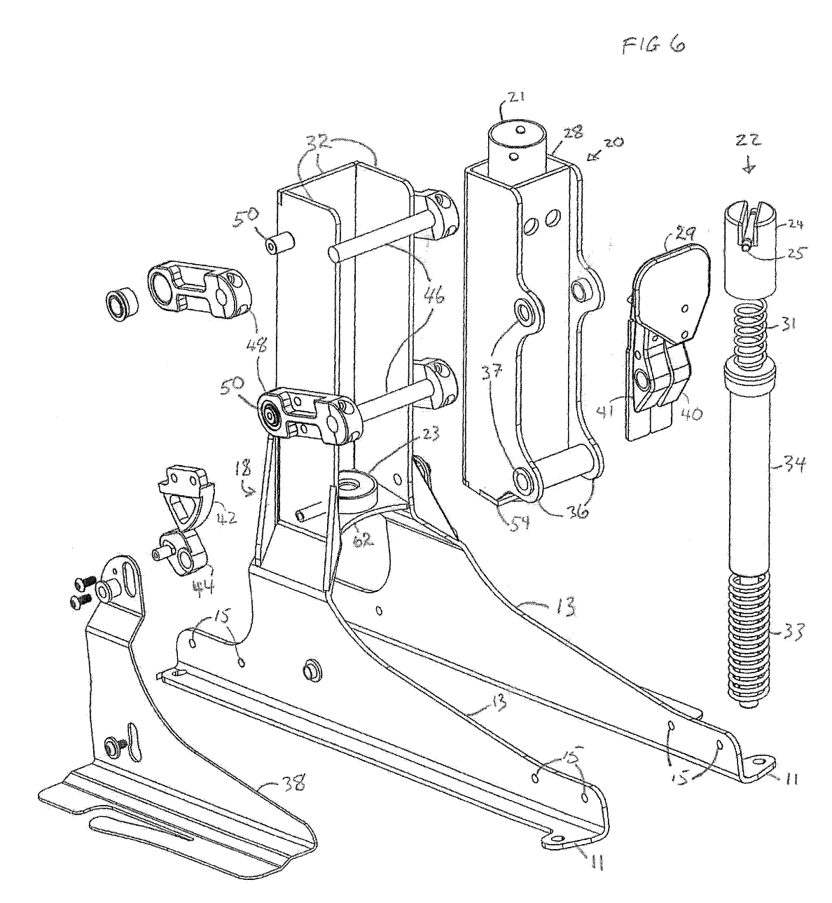

The seat system 1 is coupled to the DBPV 2 via the foot platform 10. The seat system 1 may be coupled to the DBPV 2 by any method suitable to secure a secondary structure to a primary structure, such as mechanical linkages. For example, the seat system 1 may have a frame or base weldment 18 that is secured to the foot platform 10 by a plurality of bolts 3 passed through existing holes in the base 18 and secured into existing holes in the foot platform 10 of the stock DBPV 2. The base 18 is configured in an inverted modified Y shape to fit over the console 6 on the foot platform 10 of a DBPV 2. Referring now to FIG. 5, the arms 4 of the Y may include a horizontal portion 11 that is flush with the foot platform 10 and a vertical portion 13 that extends up from the foot platform 10. The vertical portion 13 may have a plurality of holes 15 to allow attachment of accessory pieces, such as a trailer hitch, if desired. Referring to FIG. 6, the base 18 also includes a three-sided fixed post 32 (the base of the Y shape), with a plate 62 at the crux of the Y of the base 18 supporting a shock cup 23 that supports the lower end of the shock attenuation gas spring 34.

In one embodiment, the floating seat post receiver 20 is coupled to the fixed post 32 on the base 18. The coupling may be accomplished by any suitable method that allows vertical movement of the floating seat post receiver 20 in relation to the fixed post 32. For example, the floating seat post receiver 20 may be coupled to the fixed post 32 by a four bar linkage on each side, the four bar linkage consisting of the two pivoting bars 48, the fixed post 32 and the floating seat post receiver 20. This four bar linkage provides secure attachment of the floating seat post receiver 20 to the fixed post 32 while allowing vertical movement of the floating seat post receiver 20 perpendicular to the plane of 11. In a particular embodiment, the floating seat post receiver comprises a sleeve 28 having at least one flange 36. Each flange 36 contains two holes 37, each hole configured to accommodate a shaft 46. Each shaft 46 is coupled to a bar 48 on each end of the shaft 46 such that each bar 48 may pivot about the hole 37 in flange 36. The opposite end of each bar 48 is then coupled to the fixed post 32 such that the bar may pivot or rotate about the stub shaft 50 to the fixed post 32.

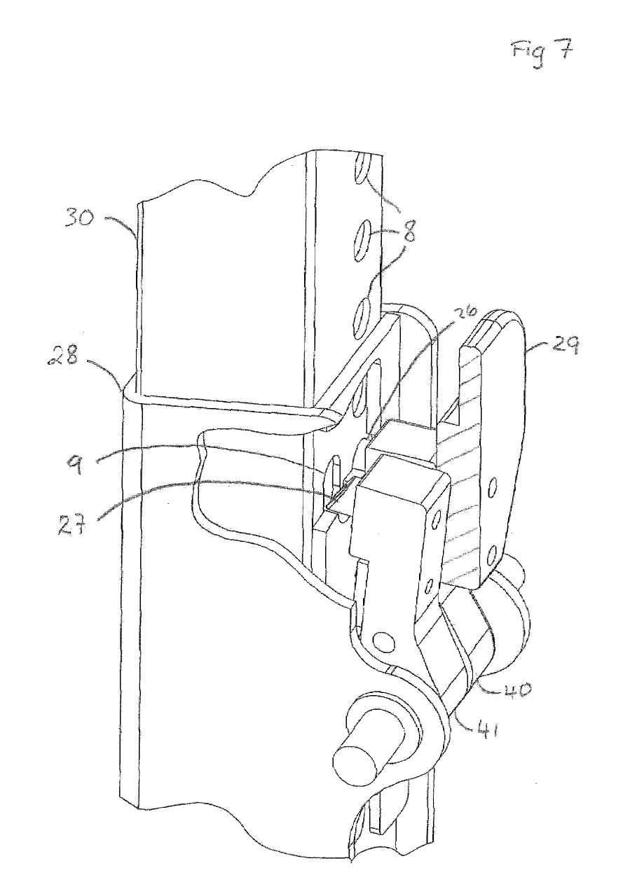

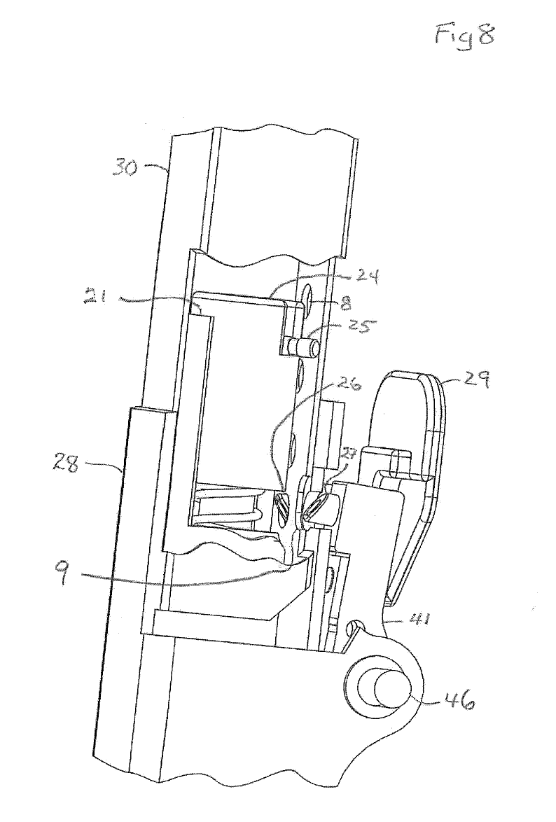

Referring to FIGS. 7 and 8, a height adjustable seat post 30 is situated in the sleeve 28. The height of the seat post 30 may be varied by any method of varying the height of a support. For example, a seat height adjustment pin 26 may be inserted through a hole in the sleeve 28 and into one of a variety of holes 8 in the seat post 30. The pin 26 secures and supports the seat post 30 at a height determined by the position of the hole 8 in the seat post 30 into which the adjustment pin 26 is inserted. Preferably the adjustment pin 26 is beveled to permit rapid one hand adjustment of seat height in the vertical direction. A second pin 27 is offset from the first pin 26 and is beveled with its face rotated 180 degrees from pin 26, and engages a stop limit hole 9 at the top end of travel to prevent the accidental removal of seat post 30. In a particular embodiment, the pin 26 and second pin 27 are each installed in a spring loaded rocker 40 and 41, respectively. Rocker 40 containing pin 26 is connected to a lever 29 such that the lever 29 may have an initial resistance for a distance that corresponds to releasing the first pin 26. Rocker 41 containing pin 27 is coupled to rocker 40 such that lever 29 engages rocker 41 with a second, greater resistance for a distance that corresponds to releasing the second pin 27. Thus the same lever 29 allows adjustment, and controlled removal of the seat post 30.

As an alternative example, the seat height adjustment pin 26 may comprise a gear that engages with a height adjustment system such that turning the adjustment pin 26 causes the seat post 30 to be raised or lowered. As yet another alternative example, a motor or series of motors coupled to a control adjusts the seat height and may be adjusted before the user mounts the vehicle 2 or while the user is seated. Additionally, the seat post 30 may be custom built to have the stop limit holes configured to set a maximum height that is configured to maximize the comfort of a particular user. The height of the seat may be adjustable to allow for different heights of the user in different situations. For examples, a security guard user may wish to be at a taller, more “authoritative” height for patrol, and lower, more “social” height for conversation with the public.

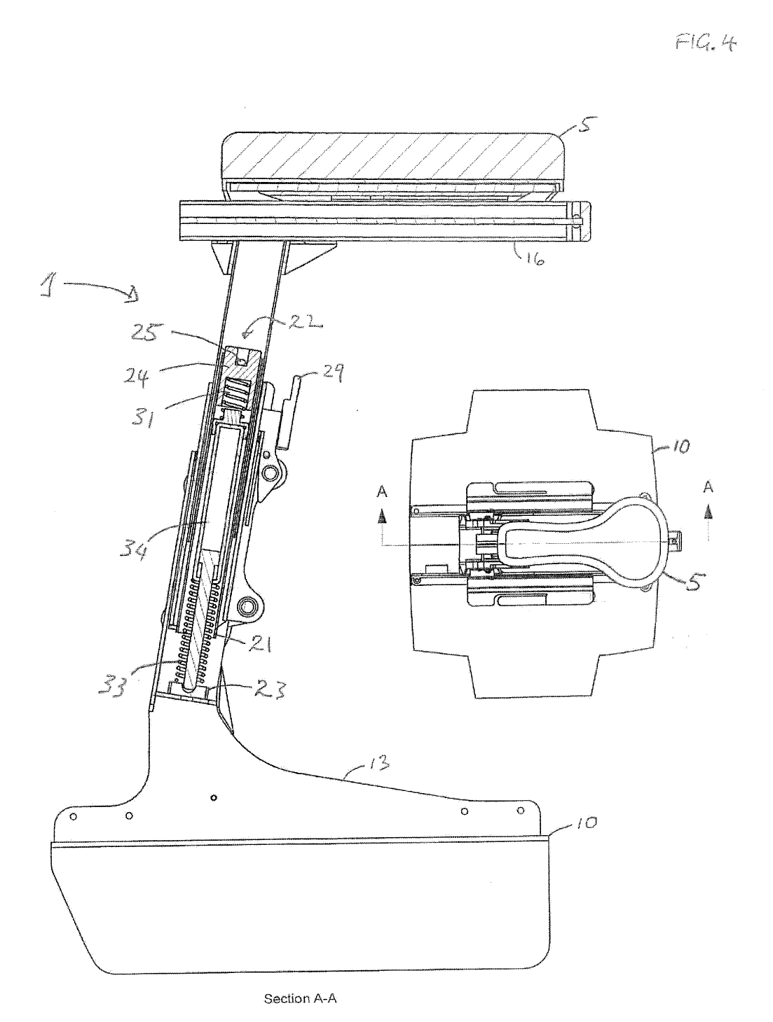

The shock tube 21 of the seating system 1 houses a support spring 31 (see FIGS. 4 and 6). The support spring 31 supports the weight of the seat 5, the seat post 30, and the floating support 20. The support spring 31 prevents the weight of the seat 5, the seat post 30, and the floating seat post receiver 20 from triggering the rider present sensors 14 in the foot platform 10.

One particular rider interface includes a seat 5 that may be similar to a unicycle seat in design to permit both standing and seated use of the dynamic balancing vehicle 2. The seat 5 is mounted on a rail 16 so as to permit the user to slide the seat 5 back and forth. The seat 5 may have a lip 58 configured to fit in a channel 60 on the rail 16 to allow limited movement of the seat. In this embodiment, sliding the seat forward would move the center of gravity of the user forward. This allows the user to set a trim position, or to stabilize the speed of the DBPV 2 when the user is in an upright position. Once the trim position is set and the DBPV 2 begins moving, the seat 5 is substantially stationary relative to the foot platform 10. In a particular embodiment, the seat 5 may be locked into position on the rail 16 once the trim position is set. The locking of the seat 5 in a trim position may be performed by any suitable method, such as by use of a pin and series of holes in the rail, or by a clamp or other method. The seat 5 may alternatively be mounted on the rail 16 via a gear system that allows a user to adjust the trim position by turning a knob that in turn moves the seat forward and backward. In another embodiment, the seat may be configured to rock back and forth as the user shifts weight forward or backward. The seat 5 and rocking mechanism or rail 16 are attached to the seat post 30 that is inserted into the seat post receiver 20.

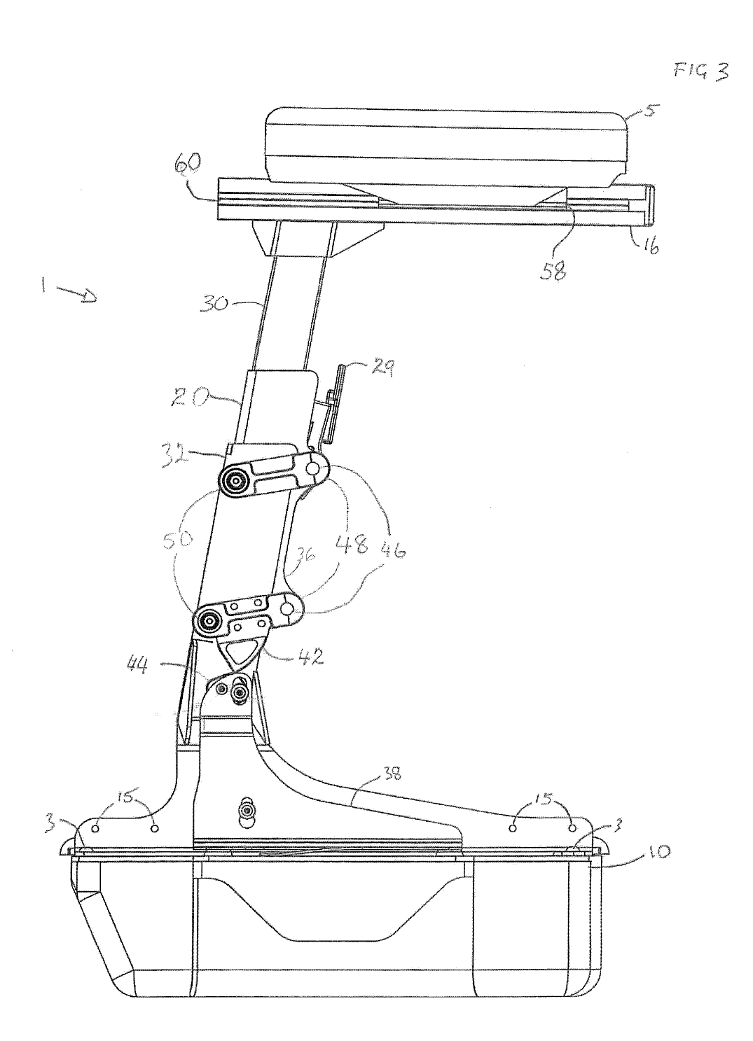

The floating seat post receiver 20 may provide for two-step vertical movement once the height is adjusted and fixed. The first part of the vertical movement, e.g. ¼″ to ½″, is resisted by the support spring 31 (see FIG. 6), and transfers at least some of the weight of the user to engage the standard foot platform switches 14 in the DBPV 2 via a rider sensor activator 38 and activates the automatic balance functions of the vehicle. Alternatively, referring to FIGS. 3-7 the rider present sensors 14 may be activated via a cam mechanism coupling the floating seat post receiver 20 to the rider sensor activator 38. A cam 42 is integrated or coupled to the lower bar 48 of the four bar linkage. A cam follower 44 is coupled to the footpad linkage 38 such that when weight or pressure causes the downward movement of the floating seat post receiver 20 the cam 42 engages the cam follower 44 to transfer the downward movement to the footpad linkage 38 and thus to the rider present sensors 14 of the DBPV 2. In a particular embodiment of this alternative, the cam follower 44 is movably coupled to both the fixed post 32 and the rider sensor activator 38. The rider sensor activator has a spring 39 either integral with the rider sensor activator 38 or coupled to the rider sensor activator 38 to ensure that the rider sensor activator 38 does not engage the rider present sensors 14 when the user is not mounted on the seat 5.

The second part of the vertical travel, which may be approximately 1″ to 2″ or larger, is controlled by a built-in shock reducer assembly 22 for user comfort. In one embodiment, a combination of mechanical 33 and gas 34 springs reduces shock loads on the rider, the vehicle interface, and the entire DBPV system. The shock reducer assembly 22 is housed within the shock tube 21 that is secured at its bottom edge to sleeve 28 by connector plate 54. The top end of shock tube 21 is secured by the shock cap 24 and the shock cap locking pin 25 that allows for the placement and removal of the shock reducer assembly 22. Thus the top end of the shock reducer assembly 22 is coupled to the seat post receiver 20. The bottom end of the shock tube 21 is open to allow the shock reducer assembly 22 to extend down to the shock cup 23 that is supported by plate 62. Thus the bottom end of the shock reducer assembly 22 is coupled to the base frame 18 and thus to DBPV 2. Therefore the shock reducer assembly 22 acts to reduce downward motion of the seat 5 when installed in the floating seat post receiver 20. The shock reducer assembly 22 should be set to have sufficient spring force to be substantially immobile when the user mounts and dismounts the vehicle, but it should compress under shock loads to absorb jolts that may occur, for example, when the DBPV 2 goes off of a curb or encounters a pothole.

To use the device, a user would begin by adjusting the seat 5 to its lowest setting to get the seat 5 out of the way for mounting the DBPV 2 using the seat height adjustment lever 29. The user may also adjust the stock lean steer handle 12 to an appropriate height. The user then would mount the DBPV 2 and stand on the foot mats 7 to activate the DBPV 2. The user would then reach down and grasp seat rail 6 and pull upward to position the seat 5 to the user's preference and then sit on seat 5 of the seat system 1. The seat would transfer the weight of the user through the floating seat post receiver 20 via the cam 42 and the cam follower to the rider sensor activator 38 to activate the rider present sensors 14 in the DBPV 2. The user then may slide the seat 5 forward or backward on the rail 16 to set the trim position. The use then shifts his or her weight and/or actuates the lean steer handle 12 to operate the dynamic balancing vehicle 2. The seat 5 and the ability of the seat system 1 to move vertically allows for comfortable operation of the DBPV 2, particularly on trips of extended duration. The seat 5 also allows a user to begin a trip in the conventional standing position and shift to using the seat as and if desired, for example, if the user tires on a long trip.

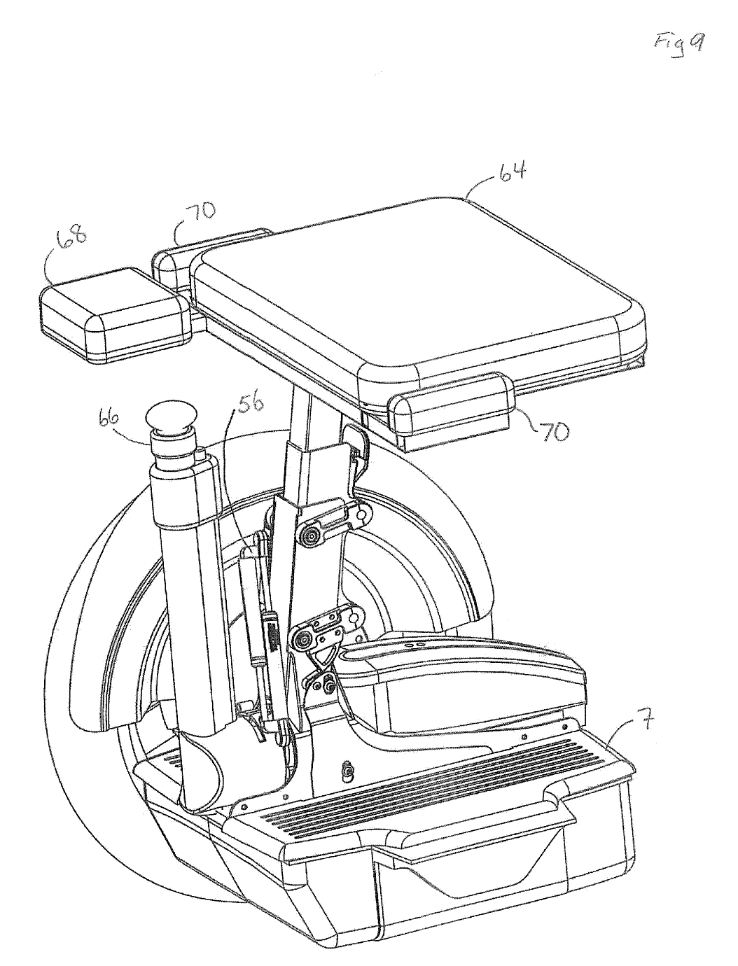

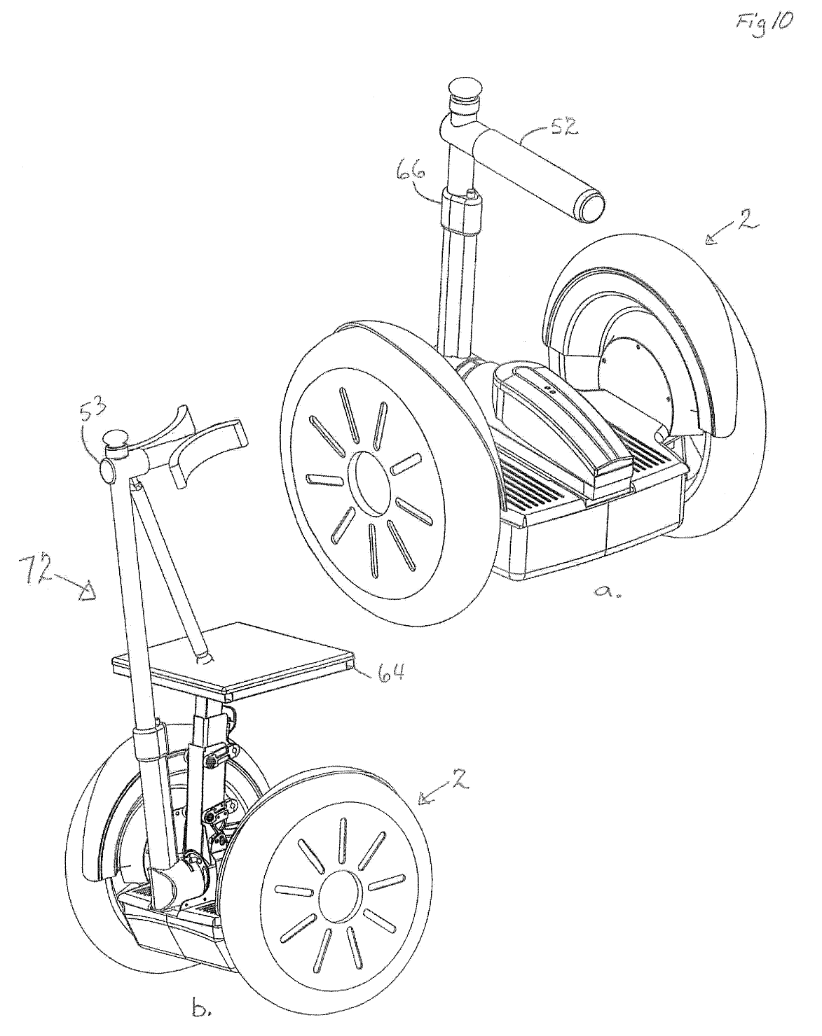

Referring now to FIGS. 9 and 10, in another embodiment of the invention, a platform seat 64 is used in conjunction with the seating system 1. The platform seat 64, which is also height adjustable, is particularly useful for persons who have lost the use of their legs. A custom or additional seat may be coupled to the platform seat 64 as and if desired. In such an embodiment, it may be desirable to alter or replace the stock steering handle 12 to allow the user to mount the DBPV 2 from the front. For example, the steering handle may be configured to be easily removed and reattached. Alternatively, the stock steering handle 12 may be replaced with a height adjustable handle 66 that may be lowered to allow a user to mount the DBPV from the front. The handle 66 may then be raised to a convenient height for use. In a particular embodiment, the handle 66 may have 3 possible levels: a lower level to allow mounting of the vehicle from the front, an intermediate level to allow seated use, and a higher level to allow standing use. The base 18 may also be coupled to the height adjustable handle 66 of the personal vehicle 2 via a steering shaft damper 56 that limits and controls unwanted movement of the height adjustable handle 66.

As yet another alternative, the stock steering handle may be altered such that the steer handle may collapse on a hinge. In this embodiment, the steer handle is folded at the hinge to allow the user to mount the DBPV 2 and then the steer handle is raised and locked back into its original position once the user is in place. The steer handle 12 may be enhanced such that the handle adjustably extends horizontally toward the user to allow easier access to the steer handle by a user with limited arm reach or mobility.

Handgrips 70 are provided on the platform seat 64 to facilitate mounting and dismounting by the user. FIG. 9 shows the height adjustable handle 66 in the down position allowing easy access to the platform seat 64 by a user. Once the user has mounted the platform seat 64, the steer handle 66 is raised to a comfortable seated operating position. In a preferred embodiment, platform seat 64 may also include leg supports 68 which may be adjustable in length and/or angle. The platform seat 64 is connected to a seat post 30 that is inserted in the floating seat post receiver 20 and seat system 2 as described above. In a specific embodiment, the steer handle 66 may include a block configured to be situated between the knees of a seated user. Such an embodiment would allow use by a user with limited or no use of the user's arms. The platform seat 64 may be augmented with a frame to improve user comfort and utility.

As an alternate use of the platform seat 64, is shown in FIG. 10b, where an able bodied user may mount the platform 64 from the rear and stand upon the platform seat 64. In this embodiment, the platform seat 64 may be configured with a foot-shaped recess for added stability of the user. The steer handle 53 may be altered in this embodiment to allow for greater height. The steer handle may also be altered to allow for hands-free operation as described below. The platform seat 64 may be raised and lowered once the user mounts the seat by, for example, a motor or series of motors coupled to a control. The added height of the platform 64 gives dynamic access of hard to reach areas to the user. Such an embodiment 72 may be useful in the construction or maintenance fields, or any application that requires access to relatively high workspaces.

In yet another embodiment of the invention, the stock steering handle 12 of a DBPV 2 is replaced by steering handle 66 with a hands-free steering bar 52 attached and located between the legs of the user, e.g. as shown in FIG. 10a. This frees the hands of the rider such that the rider may carry tools, or engage in sports or other activities where use of the hands is desirable. In a particular embodiment, the steering bar is mounted on the height adjustable handle 66. The height adjustable handle 66 allows the user to place the hands-free steering bar 52 at a comfortable height. The hands free steering bar 52 is attached to the original hub through a mechanical damper, and extends from the hub such that the legs of a user standing on the foot platform 10 may manipulate the steering bar 52. That is, when the user leans one way or another, the legs of the user engage the steering bar 52 to turn the DBPV 2 in the direction in which the user is leaning.

In yet another embodiment, a seating system 1 is provided for the user to attach to a conventional commercially available dynamic balancing personal vehicle 2. In this embodiment, the user may be provided with hardware to attach the seating system 1 to a pre-purchased dynamic balancing personal vehicle 2. The seating system 1 may be attached to the foot platform 10 or the stock steering handle 12 of the vehicle 2 as described above. Also as described above, the seating system 1 employs vertical movement, e.g. ¼″ to ½″ travel, to transfer at least some of the weight of the user to engage the standard pressure sensors 14 in the foot platform 10 in the self-balancing vehicle 2 via a footpad linkage 38.

It should be noted that there are many different and alternative configurations, devices and technologies to which the disclosed inventions may be applied. The full scope of the inventions is not limited to the examples that are described above.

We claim:

1. A dynamic balancing personal vehicle having a foot platform and rider present sensors in the foot platform, the dynamic balancing personal vehicle comprising:
a seating system consisting of a vehicle interface unit or base coupled to the foot platform; and
a rider interface unit or seat which can be quickly attached and removed from the vehicle interface unit.

2. The dynamic balancing personal vehicle of claim 1 wherein the vehicle interface unit further comprises a rider sensor activator to activate the rider present sensors in the foot platform upon mounting of the rider interface unit by a user.

3. The dynamic balancing personal vehicle of claim 2 wherein the vehicle interface unit comprises a shock attenuation device to reduce shock loads on the rider, the seating system and dynamic balancing personal vehicle.

4. The dynamic balancing personal vehicle of claim 3 wherein the shock attenuation device comprises mechanical or gas springs.

5. The dynamic balancing personal vehicle of claim 1 wherein the vehicle interface unit comprises a four bar linkage to allow vertical movement of the rider interface unit.

6. The dynamic balancing personal vehicle of claim 2 wherein a cam and cam follower control forces transferred onto the rider present sensors in the foot platform.

7. The dynamic balancing personal vehicle of claim 2 wherein the vehicle interface unit comprises a spring that prevents the weight of the rider interface unit from activating the rider present sensors in the foot platform when a rider is not mounted on the rider interface unit.

8. The dynamic balancing personal vehicle of claim 2 wherein the rider sensor activator comprises a spring integral with or coupled to the rider sensor activator to relieve pressure of the rider sensor activator on the rider present sensors when the user is not mounted on the rider interface unit.

9. The dynamic balancing personal vehicle of claim 1 wherein the vehicle interface unit allows height adjustment of the rider interface unit.

10. The dynamic balancing personal vehicle of claim 9, wherein the height of the rider interface unit is set by a pin that is beveled to allow rapid, unidirectional adjustment of the height of the rider interface unit.

11. The dynamic balancing personal vehicle of claim 1 wherein the rider interface unit is configured to allow both sitting and standing operation of the dynamic balancing personal vehicle.

12. The dynamic balancing personal vehicle of claim 1 wherein the rider interface unit comprises a seat and is configured to allow a rider to adjust or trim his or her center of gravity relative to the dynamic balancing personal vehicle by moving the seat forward and back.

13. The dynamic balancing personal vehicle of claim 1 wherein the rider interface unit is configured to elevate the rider above the dynamic balancing personal vehicle.

14. The dynamic balancing personal vehicle of claim 1 further comprising a steering handle that is height adjustable to facilitate mounting and dismounting by a user.

15. The dynamic balancing personal vehicle of claim 1 further comprising a removable steering handle.

16. The dynamic balancing personal vehicle of claim 13 further comprising a steering handle that is extended to enable the elevated rider to steer the dynamic balancing personal vehicle.

17. A dynamic balancing personal vehicle comprising a hands-free steering bar configured to reside between the legs of a user standing on the dynamic balancing personal vehicle.

18. A rider support system, configured to be attached to a dynamic balancing personal vehicle having a foot platform and rider present sensors in the foot platform, the rider support system comprising:
a vehicle interface unit or base coupled to the foot platform; and
a rider interface unit which can be quickly attached and removed from the vehicle interface unit.

19. The rider support system of claim 18 wherein the vehicle interface unit further comprises a rider sensor activator to activate the rider present sensors in the foot platform upon mounting of the vehicle interface unit by a user.

20. The rider support system of claim 19 wherein the vehicle interface unit further comprises a shock attenuation device to reduce shock loads on the rider, the seating system or the dynamic balancing personal vehicle.

21. The rider support system of claim 20 wherein the shock attenuation device comprises a mechanical and/or gas spring.

22. The rider support system of claim 18 wherein the vehicle interface unit comprises a four bar linkage to allow vertical movement of the rider interface unit.

23. The rider support system of claim 19 wherein the vehicle interface unit comprises a cam and cam follower to control forces transferred to the rider sensor activator and onto the rider present sensors in the foot platform.

24. The rider support system of claim 19 wherein a spring prevents the weight of the rider interface unit from activating the rider present sensors in the foot platform when the user is not mounted on the rider interface unit.

25. The rider support system of claim 19 wherein the rider sensor activator comprises a spring integral with or coupled to the rider sensor activator to relieve pressure of the rider sensor activator on the rider present sensors when the user is not mounted on the rider interface unit.

26. The rider support system of claim 18 wherein the vehicle interface unit provides for height adjustment of the rider interface unit.

27. The rider support system of claim 26, wherein the height of the rider interface unit is set by a pin this beveled to allow rapid, unidirectional adjustment of the height of the rider interface unit

28. The rider support system of claim 18 wherein the rider interface unit is configured to allow both sitting and standing operation of the dynamic balancing personal vehicle.

29. The rider support system of claim 18 wherein the rider interface unit comprises a seat and is configured to allow a rider to trim his or her center of gravity relative to the dynamic balancing personal vehicle by moving the seat forward and back.

30. The rider support system of claim 18 wherein the rider interface unit is configured to allow for only seated operation of the dynamic balancing personal vehicle.

31. The rider support system of claim 18 wherein the rider interface unit provides a user platform above the foot platform of the dynamic balancing personal vehicle.

32. The rider support system of claim 18 further comprising a steering handle that is height adjustable to facilitate mounting and dismounting by a user.

33. The rider support system of claim 18 further comprising a removable steering handle.

34. The rider support system of claim 31 further comprising a steering handle of the dynamic balancing personal vehicle that is extendable to enable the elevated rider to steer the dynamic balancing personal vehicle.

35. A method of altering a dynamic balancing personal vehicle having a foot platform and rider present sensors in the foot platform to allow use of various rider interface units comprising the acts of:
providing a vehicle interface unit or base for supporting a seat; and
coupling the vehicle interface unit or base to the foot platform through a support which permits sufficient vertical movement of a rider interface unit in response to the weight of a rider to activate rider present sensors in the foot platform.

36. The method of altering a dynamic balancing personal vehicle having a foot platform and rider present sensors in the foot platform to allow seated use of the method of claim 35 wherein the seat is coupled to the base via a four bar linkage.

37. A method of mounting a dynamic balancing personal vehicle having a seat and a steer bar from the front comprising the acts of:
providing a steer bar which is adjustable in height;
lowering the steer bar to a lowered position;
mounting the seat of the dynamic balancing personal vehicle; and
raising the steer bar to a raised position.

38. A method of modifying a dynamic balancing personal vehicle having a steer bar for hands-free operation, which comprises:
replacing the steer bar with a hands-free steer bar which resides between the legs of a user standing on the foot platform of the dynamic balancing personal vehicle.

39. A height adjustable rider support system comprising
a seat post having a plurality of holes; and
a first pin that secures and supports the seat post at a height determined by the position of the hole in the seat post into which the adjustment pin is inserted, wherein the first pin is beveled to permit rapid one hand adjustment of seat height in the vertical direction.

40. The height adjustable rider support system of claim 39 further comprising a second pin offset from the first pin, beveled with its face rotated 180 degrees from the bevel of the first pin to engage a stop limit hole in the seat post.

41. The height adjustable rider support system of claim 40 wherein the first pin and second pin are each installed in a spring loaded rocker, wherein the rockers are coupled to a lever such that the lever may have an initial resistance for a distance that corresponds to releasing the first pin, and a second, greater resistance for a distance that corresponds to releasing the second pin.
